(19) United States
(12) Patent Application Publication
(10) Pub. No.: US 2003/0106785 A1
(43) Pub. Date: Jun. 12, 2003

(54) Connecting bars for electrical devices and apparatus for different nominal currents having a cavity

(76) Inventors: Michael Bach, Berlin (DE); Detlev Schmidt, Berlin (DE); Michael Sebekow, Berlin (DE); Guenter Seidler-Stahl, Berlin (DE); Ingo Thiede, Berlin (DE); Sezai Tuerkmen, Berlin (DE)

Correspondence Address: HARNESS, DICKEY & PIERCE, P.L.C., P.O.BOX 8910, RESTON, VA, 20195, US

(21) Appl. No.: 10/312,531

(22) PCT Filed: Jun. 25, 2001
(86) PCT No.: PCT/DE01/02350

(30) Foreign Application Priority Data
Jun. 28, 2000 (DE) 10032653.6

(51) Int. Cl. H01R 33/96

(52) U.S. Cl. 200/51.1

(57) ABSTRACT

The invention relates to connecting bars (4) made from profiled semifinished products and having a cavity, said bars having the same outer dimensions for different nominal currents and being intended for connecting the electrical components of electrical devices and apparatus to an external electrical circuit, wherein the connecting bars extend through the window opening located in the wall of the devices or apparatus and are fixed in the housing by fixing means consisting of two or more partial parts (11, 12) embodied as profiles, which are configured in such a way that they can be connected to one another by positive fit or otherwise to a hollow connecting bar (4). The partial parts (11, 12) have one or several legs (13; 16; 17), the length of which defines the height of the connecting bar (4).

The invention relates to connecting rails, which are produced from profiled semi-finished products and are provided with a cavity, for connecting the electrical components of electrical appliances and apparatuses to an external circuit, with the connecting rails extending through window openings located in the appliance or apparatus wall and being fixed in the housing by attachment means. Connecting rails of this type have been proposed in German Patent Application 199 39 710.4.

In this way, by way of example, a system-side feeder rail or some other suitable connection element for supplying or outputting power can be connected to the part of a connecting rail which is passed out of the housing to the exterior. The connecting rail is in this case generally arranged fixed in the insulating wall body of an appliance or apparatus, and this is generally achieved by means of bushing openings and attachment elements.

The connecting rails also have to be designed such that they can be produced economically and are suitable for carrying out specific functions. These functions are: the current-carrying capacity, heat dissipation, a surface for connections for feeder rails as well as absorbing and transmitting static and dynamic forces. This is thus a point which is subject to high stresses both in terms of forces and dynamically.

Furthermore, it is also intended to be possible to accommodate connecting rails for different current levels in one standard housing with standard bushing openings. In conventional appliances and apparatuses, screws are used as the attachment means for the connecting rail, which extend through openings which are arranged transversely with respect to the longitudinal axis of the connecting rails, and which are generally held by a female thread provided in the wall of the corresponding housing. For mechanical strength reasons, metallic recessed nuts or push-in nuts are used for this purpose, in a housing which is composed of an insulating material.

In consequence, the production and installation of such connecting rails is associated with high material and manufacturing costs. The use of connecting rails which are sawn from a profile material with one or more projections, such that the connecting rails are passed through a hole and the projection or projections of the profile material is or are used as stops for the connecting rail on the switch housing, thus forming the means for transferring the switching forces to the housing, has therefore been proposed, for example for low-voltage circuit breakers.

This on the one hand results in the position of the fixed contact with respect to the housing being defined in switches such as these while, on the other hand, the attachment point is relieved of the load from said forces so that only a fixing force is required here, but no load is produced by the shear force or positioning force.

A connecting rail such as this for a low-voltage circuit breaker, having an integrally formed projection, has been proposed for overcoming the abovementioned cost in DE 196 43 607 A1. This connecting rail is passed from the inside through the bushing opening in the housing wall, and is supported on the housing rear wall by means of a projection. Special profiles are used for producing this connecting rail, which have an integrally formed strip, from which pieces are then cut off in order to form the connecting rail.

In the case of low-voltage circuit breakers, it has until now been normal to use connecting rails of different thickness, depending on the rated current, within one range. These connecting rails are likewise produced from profiles by sawing. The housing has standard cutouts for the connecting rails, which are each designed for the highest rated current level. Spacers which are made of plastic and fill the intermediate spaces are used for thinner connecting rails, for lower rated current levels. The installation of the spacers has the disadvantage of additional costs for these parts, as well as increased installation costs, and they form a fault source when current paths are installed at the customer end.

In all these known electrical appliances and apparatuses, the connecting rails are produced from solid material, irrespective of the rest of the production technology. This means that the rails also have different cross sections for different current levels, and thus have different external dimensions; a disadvantage which has already been mentioned above.

Hollow current-carrying conductors are known from high-voltage and radio-frequency technology. In these hollow conductors, the hollow configuration is used only for the purpose of reducing the corona-discharge losses from the conductors, that is to say the emission of energy from sharp edges or small radii, or to take account of the skin effect, which is based on the fact that power is transmitted only in the outer region of a conductor at high frequencies, but not for the purpose of ensuring a different current load capacity with a standard external cross section.

A current-carrying hollow arrangement is also described in U.S. Pat. No. 3,597,713, which discloses an appliance as a replacement for a high-voltage fuse link, in which a combination of a vacuum interrupter with a switching handle is described, which switching handle has an eye for operation, in a similar way to a high-voltage or medium-voltage switch disconnector. An electronic circuit is installed in a hollow connecting piece of the appliance. Although this means that a current-carrying hollow part on an electrical switching device has been disclosed, this is, however, used only to accommodate another component of the appliance, namely said electronic circuit, and not for controlling the current-carrying capacity of the component.

In another reference, it has already been proposed for hollow connecting rails to be used for low-voltage circuit breakers, which are produced by sawing them from hollow profile material and which may have not only one but also a number of cavities. In this case, these connecting rails have the same external cross section for all the different current levels. The current-carrying capacity is regulated by means of the wall thickness of the hollow rail, which forms the conductive, current-carrying cross section. This means that a larger inner cavity is formed by virtue of small wall thicknesses for relatively low current levels, and that a smaller inner cavity is formed as a result of the wall thicknesses being greater for relatively high current levels, which, in the extreme, can lead to a solid configuration without any cavity for the maximum rated current level. The bushing openings in the respective appliance and apparatus housings are then designed for the external dimensions required for the maximum rated current level. The production of such hollow profiles from a number of materials which are preferably used for the production of such connecting rails is, however, associated with considerable difficulties.

The object of the present invention is therefore to design hollow connecting rails such that they have the same external cross section even for different rated current values and can be used without any additional spacers in appliance and apparatus housings with standard bushing openings, but in which the problems involved in the production of hollow semi-finished profiles can be avoided.

According to the present invention, this object is achieved in that the cavity in the connecting rail is produced by the connecting rail being composed of two or more piece elements, which are in the form of profiles and are designed such that they can be connected to one another in an interlocking manner or in some other way to form a hollow connecting rail. Such profile elements can be manufactured easily and without the problems which occur with the production of hollow profiles. The connecting rail is preferably assembled from two profiled piece elements, of which the first piece element forms the upper part of the connecting rail and the second piece element forms the lower part of it. This results in planar upper and lower rail surfaces, which is particularly important with respect to use for push-in switches, in order to ensure that they slide correctly into the push-in blade contacts. The piece elements have one or more limbs whose lengths govern the height of the connecting rail. This means that the connecting rails have the same external dimensions for all current levels, corresponding to the standard dimensions of the bushing windows in the rear wall of the low-voltage circuit breaker. The current-carrying capacity of the connecting rail is in this case governed by the thickness of the material.

One or more limbs of each piece element is or are expediently provided with connection elements, which engage in an interlocking manner in mating elements on the respective other piece element.

Three limbs are advantageously provided, of which two are arranged on one piece element and one is arranged on the other piece element. This makes it easier to manufacture the piece elements than if all the limbs were arranged on one piece element. The piece elements are connected to one another by means of one or more interlocking connections and/or partially by soldering, welding or the like. Any holes required for attachment of the system-side busbars are advantageously stamped.

The invention will be explained in more detail in the following text, to assist understanding, with reference to a preferred exemplary embodiment, although this does not restrict the scope of protection.

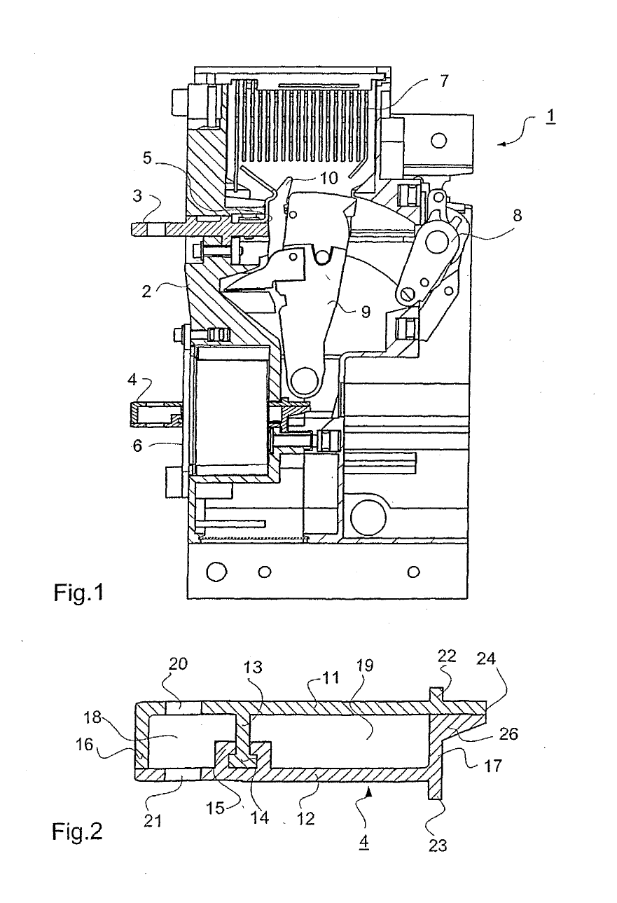

FIG. 1 shows, schematically, a section view of a low-voltage circuit breaker.

FIG. 2 shows a section view of one possible advantageous embodiment of a lower connecting rail according to the present invention.

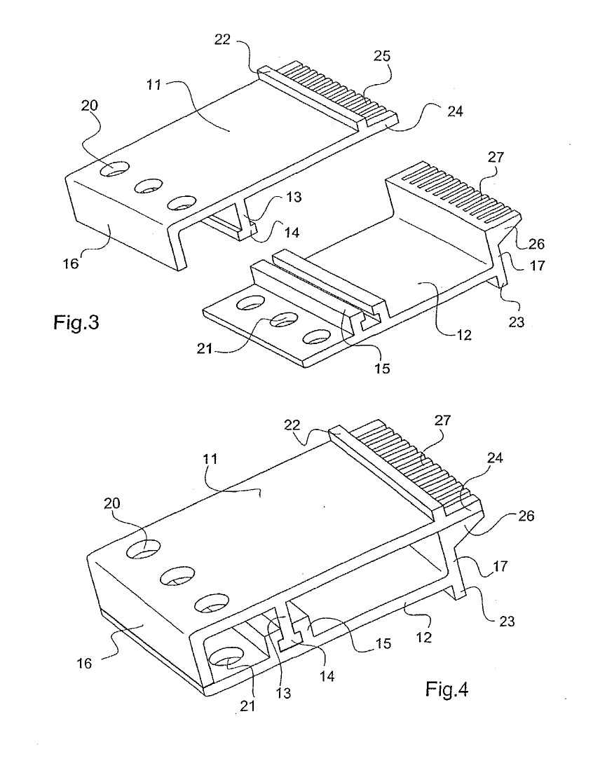

FIG. 3 shows a perspective illustration of the connecting rail shown in FIG. 2, in the state before the piece elements are joined together.

FIG. 4 shows a perspective illustration of the connecting rail shown in FIG. 2, after the piece elements have been joined together.

FIG. 1 shows a low-voltage circuit breaker 1, schematically and in the form of a section view. The upper connecting rail 3, which is shown in conventional form, and the lower connecting rail 4, which is illustrated in the form according to the invention and is passed through the current transformer 6, are passed through the rear wall 2 of the low-voltage circuit breaker 1. The fixed switching contact 5 is located on the upper connecting rail 3 and the moveable switching contact 10, which is located on a contact support 9 that is connected to the switch drive 8, is connected to the lower connecting rail 4, via flexible connections which are not shown. The arcing chamber 7 is arranged above the fixed switching contact 5 and the moveable switching contact 10.

FIG. 2 shows one possible advantageous embodiment of a lower connecting rail 4 according to the present invention, in the form of a side view. This comprises a profiled upper piece element 11 and a likewise profiled lower piece element 12. These are connected to one another in an interlocking manner by pushing one into the other, by means of a web 13 which is provided on the upper piece element 11, has a transverse web 14 located at its end and has a guide rail 15 provided on the lower piece element 12. In addition, the upper piece element 11 has an angled part 16, and the lower piece element 12 has a part 17 arranged at right angles, both of whose dimensions are designed such that they form connection webs between the upper piece element 11 and the lower piece element 12, with their lengths governing the height of the connecting rail 4. In addition to the interlocking connection described above, the two piece elements 11, 12 are additionally connected to one another by soldering, welding or the like at the points where the part 16 makes contact with the lower piece element 12 and where the part 17 makes contact with the upper piece element 11.

The described arrangement results in a hollow connecting rail 4, which has two cavities 18, 19. Holes 20, 21 are provided for attachment of the system-side busbars, and are expediently produced by stamping. The projections 22, 23 are used as stops for axial fixing of the connecting rail 4 on the switch housing. FIG. 3 shows a perspective illustration of the connecting rail 4 shown in FIG. 2, in the state before the piece elements 11, 12 have been joined together, and FIG. 4 shows the same connecting rail 4 after the piece elements 11, 12 have been joined together, likewise in the form of a perspective illustration. Identical parts from FIG. 2 are provided with the same reference symbols in these figures, and there is therefore no need to describe these parts once again. The two FIGS. 3 and 4 are intended only to illustrate more clearly the function of the web 13 with its transverse web 14 and the guide rail 15. These elements provide a first fixing for the two piece elements 11, 12, in order to make it easier to connect them by soldering or welding to the other contact points mentioned above.

Cutouts 25 are provided in an extension 24 on the upper piece element 11 for attachment of the flexible conductor cables which connect the lower connecting rail to the moveable switching contacts. The part 17, which is arranged at right angles, of the lower piece element 12 has a projection 26, in which cutouts 27 are likewise provided, which are aligned with the cutouts 25 in the upper piece element 11 so that the flexible conductor cables mentioned above can be inserted into the cutouts 25, 27 in the two piece elements 11, 12. In consequence, the two piece elements 11, 12 are electrically connected to the conductor cables while said conductor cables are being soldered or welded in and, in consequence, are subject to uniform current loads. The cutouts 25; 27 may, of course, also be milled after assembly.

The advantage of this embodiment according to the invention is that these profile elements are easy to produce. The current-carrying capacity of the connecting rail is governed by the thickness of the material and not by the external dimensions.

List of reference symbols

1 Low-voltage circuit breaker

2 Rear wall

3 Upper connecting rail

4 Lower connecting rail

5 Fixed switching contact

6 Current transformer

7 Arcing chamber

8 Switch drive

9 Contact support

10 Moveable switching contact

11 Upper piece element

12 Lower piece element

13 Web

14 Transverse web

15 Guide rail

16 Angled part

17 Part

18 Cavity

19 Cavity

20 Hole

21 Hole

22 Projection

23 Projection

24 Extension

25 Cutout

26 Projection

27 Cutout

1. A connecting rail for electrical appliances and apparatuses, for different rated currents, with a cavity, produced from profiled semi-finished products, for connection of the electrical components of electrical appliances and apparatuses to an external circuit, with the connecting rails extending through window openings located in the appliance or apparatus wall and being fixed in the housing by attachment means, characterized
in that the connecting rail comprises two or more piece elements (11, 12) which are in the form of profiles and are designed such that they can be connected to one another in an interlocking manner or in some other way to form a hollow connecting rail (4).

2. The connecting rail as claimed in claim 1, characterized
in that the connecting rail is composed of two profiled piece elements (11, 12), of which the first piece element (11) forms the upper part of the connecting rail (4) and the second piece element (12) forms the lower part of it.

3. The connecting rail as claimed in claim 1, characterized
in that the piece elements (11, 12) have one or more limbs (13; 16; 17) whose lengths determine the height of the connecting rail (4).

4. The connecting rail as claimed in claim 1, characterized
in that one or more limbs (13) of each piece element (11) are provided with connection elements (14) which engage in an interlocking manner in mating elements (15) on the respective other piece element (12).

5. The connecting rail as claimed in claim 1, characterized
in that three limbs (13; 16; 17) are provided, of which two limbs (13; 16) are arranged on one piece element (11) and one limb (17) is arranged on the other piece element (12).

6. The connecting rail as claimed in claim 1, characterized
in that the piece elements (11, 12) are connected to one another by one or more interlocking connections (14, 15) and/or partially by soldering, welding or the like.

7. The connecting rail as claimed in claim 1, characterized
in that holes which are required for attachment of the system-side busbars are stamped.
